(19) United States
(12) Patent Application Publication
(10) Pub. No.: US 2007/0194602 A1
(43) Pub. Date: Aug. 23, 2007

(54) Fused Thermoplastic Scuff and Wall Plate

(76) Inventor: Rodney P. Ehrlich, Monticello, IN (US)

Correspondence Address: TREXLER, BUSHNELL, GIANGIORGI,;BLACKSTONE & MARR, LTD., 105 WEST ADAMS STREET, SUITE 3600, CHICAGO, IL, 60603, US

(21) Appl. No.: 11/461,585

(22) Filed: Aug. 1, 2006

Related U.S. Application Data
(60) Provisional application No. 60/775,246, filed on Feb. 21, 2006.

(51) Int. Cl. B62D 25/02

(52) U.S. Cl. 296/186.1

(57) ABSTRACT

The scuff and wall plate is formed by fusing a thermoplastic fiberglass-reinforced plastic scuff plate to a thermoplastic fiberglass-reinforced plastic wall liner by glass fiber blooming. The fusion blooming can be accomplished by vibration welding or high frequency welding. Because the scuff plate and wall liner are fused, a small lap area is all that is needed to keep the liner and scuff plate together.

### PRIORITY

This application claims the priority of United States Provisional Patent Application No. 60/775,246, filed on Feb. 21, 2006, entitled “Fused Thermoplastic Scuff Plate”, which disclosure is herein incorporated by reference.

### FIELD OF THE INVENTION

This invention relates to the field of transportation, particular to the field of trailers or truck bodies.

### BACKGROUND OF THE INVENTION

Prior art semi-trailers are usually manufactured with a wall liner on the interior sidewalls of the cargo compartment to protect the structural components, such as the sheet and posts used to form the sidewalls of the trailer. The most popular wall liner is one-quarter-inch plywood. Other types of wall liners include continuous sheets of fiberglass-reinforced plastic (“FRP”).

Damage to the wall liner occurs most often near the floor area. Accordingly, a scuff plate, a strip of additional protective material, is usually applied over the wall liner, extending up from the floor of the trailer, usually about one-foot in height. Scuff plates are used with both wooden walls as well as with composite sidewalls.

The most common scuff plate is a thin (0.050 to 0.090-inch) sheet of corrugated steel or aluminum, fastened to the posts of the sidewall of the trailer with blind fasteners. The fasteners used to attach metal scuff plates, however, tend to pull out, shear off, or otherwise leak. The same problem has occurred with non-metallic scuff plates. The use of adhesives to apply non-metallic scuff plates has achieved limited success due to high cost, problems in applying the bonding material, and bond failures.

A new FRP wall liner, made of glass-reinforced thermoplastic, has been introduced. This wall liner has improved puncture and abrasion resistance over previous FRP wall liners, but still requires a scuff plate. The use of blind fasteners to attach scuff plates to thermoplastic FRP wall liners has met with the same problems describe above. The use of adhesives still has high cost, problems in applying the bonding material, and bond failures.

A sidewall 20 having a scuff plate 22 mounted therein as known in the art is shown in side view in FIG. 1. Scuff plate 22 is bonded to the wall liner 24 of the sidewall 20 by adhesive 26, applied to lap area 28 (the adhesive 26 is shown enlarged for illustration purposes). Three modes of failure are possible. There could be a failure at the surface where scuff plate 22 meets adhesive 26, there could be a failure at the surface where wall liner 24 meets adhesive 26, or there could be a failure within adhesive 26.

### BRIEF DESCRIPTION OF THE DRAWINGS

FIG. 1 is a cross-sectional view of a scuff plate bonded to a sidewall, as known in the prior art.

FIG. 2 is a perspective view of a trailer in which a fused scuff and wall plate of the preferred embodiment of the present invention is provided.

FIG. 3 is a cross-sectional view of a fused scuff and wall plate of the preferred embodiment of the present invention, mounted to the structural components of on the interior of the trailer.

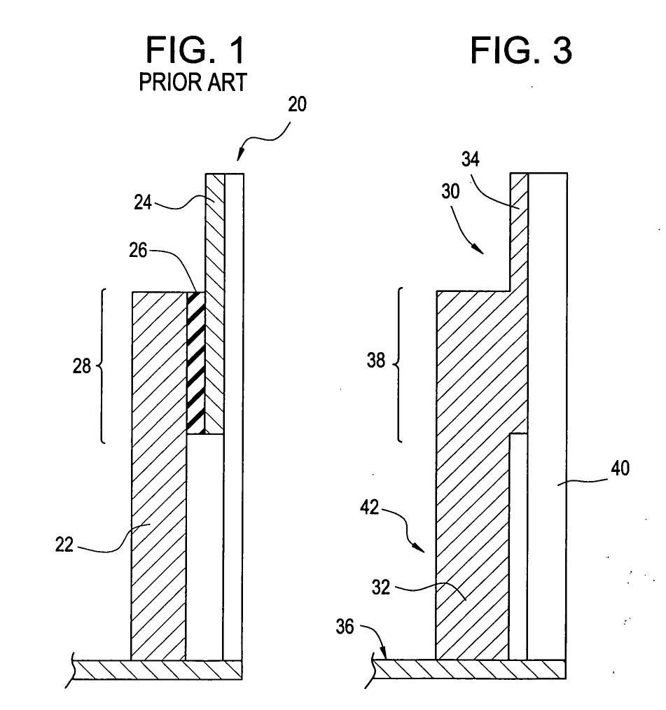

### BRIEF SUMMARY OF THE INVENTION

The scuff and wall plate of the present invention are formed by fusing a thermoplastic fiberglass-reinforced plastic scuff plate to a thermoplastic fiberglass-reinforced plastic wall liner by glass fiber blooming. The fusion blooming can be accomplished by vibration welding or high frequency welding. Because the scuff plate and wall liner are fused, a small lap area is all that is needed to keep the liner and scuff plate together.

### DETAILED DESCRIPTION OF THE PREFERRED EMBODIMENT

While the invention may be susceptible to embodiment in different forms, there is shown in the drawings, and herein will be described in detail, a specific embodiment with the understanding that the present disclosure is to be considered an exemplification of the principles of the invention, and is not intended to limit the invention to that as illustrated and described herein.

A thermoplastic FRP scuff plate 32 is made of a thermoplastic resin, co-mingled with glass fibers and then woven into a cloth. The co-mingled cloth is then consolidated with heat and pressure, allowing the thermoplastic to melt, thereby fusing the glass reinforcement. The sheet is then cooled under pressure and a thermoplastic coating is applied on the outer surfaces to create a smooth appearance. This surface is cosmetically desirable but causes problems with various bonding agents. Accordingly, bonding together two sheets of thermoplastic with an adhesive produces the three modes of failure described above. A thermoplastic FRP wall liner 34 is formed in the same manner. The two sheets need not be the identical type of thermoplastic FRP.

The present invention avoids the problems that arise in the use of adhesives in this situation, by using a process called “glass fiber blooming”. In this process, a surface of the scuff plate 32 is heated, and a surface of the wall liner 34 is heated, thereby melting the resin and releasing the glass fibers in each. When the scuff plate 32 and the wall liner 34 are bloomed in this manner and joined together at their bloomed surfaces, re-consolidation occurs, fusing the layers together just like the original glass-fiber reinforced sheet. The fused area is as strong as the parent material of each individual sheet. Accordingly, by the use of the glass fiber blooming process, the scuff plate 32 is fused to the wall liner 34 to produce a scuff and wall plate 30 which is mounted to the structural components of a sidewall 40 of a trailer 18.

The use of this method to fuse thermoplastic the scuff plate 32 to the wall liner 34 requires quite a bit of heat, if the blooming process is applied across the entire 12-inch height of the scuff plate 32. Additionally, unless heat is applied evenly, the wall liner 34 tends to warp.

Accordingly, the preferred embodiment of the present invention comprises the use of the blooming and fusing technique along a small strip of the scuff plate 32 and the wall liner 34, such as a one-inch strip. The total amount of heat needed is much less than if the entire 12-inch wide scuff plate 32 was heated, leading to energy savings. The warping problem in the wall liner 34 is also ameliorated by this technique.

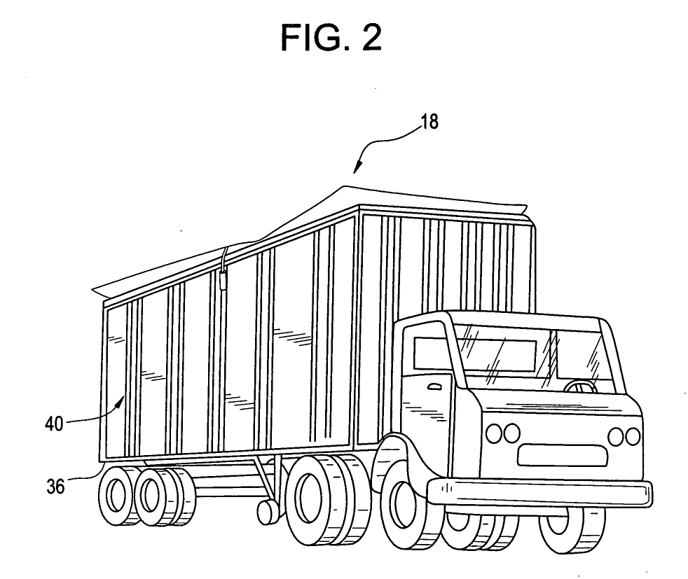

A cross-sectional view of the fused scuff and wall plate 30 of the preferred embodiment is shown in FIG. 3. The sidewall can be used in a cargo compartment 42 in a trailer of a semi-tractor/trailer combination, the interior of a straight truck, or anywhere else where a scuff plate is needed, such as a railroad car, barge, ferry, or cargo plane.

Scuff plate 32, because it is most likely to encounter objects such as forklifts, carts, and pallets, is preferably much thicker than the wall liner 34. Additionally, because the scuff plate 32 is relatively thick, the wall liner 34 does not need to extend all the way to the floor 36 of the cargo compartment 42. Instead, the wall liner 34 preferably extends to overlap the scuff plate 32 only at lap area 38. Because the scuff plate 32 and wall liner 34 are fused, a small lap area 38 is all that is needed to keep the wall liner 34 and scuff plate 32 together. In the preferred embodiment, the scuff plate 32 is twelve inches high and lap area 38 is about one and one-quarter inches high. Accordingly, the wall liner 32 can be mounted to the remainder of the structural components of the sidewall 40 approximately 10.75 inches above the floor 36 of cargo compartment 42.

The blooming and fusing process makes scuff plate 32 and wall liner 34 a homogeneous composition. This assembly can be achieved through various manufacturing methods or processes including vibration/high frequency welding Accordingly, scuff and wall plate 30 is as strong as the parent thermoplastic FRP material originally used.

Moreover, the three modes of failure described above for bonded scuff plates do not exist in scuff and wall plate 30. Since the fusing process has made scuff plate 32 and wall liner 34 a homogenous composition, there are no boundary surfaces between scuff plate 32 and wall liner 34 at which a failure can occur, and no adhesive in which a failure can occur.

Additionally, because fused scuff and wall plate 30 does not require the use of adhesives, lower material costs result. Accordingly, a low-cost joining method produces a very strong scuff plate-wall liner composition.

While a preferred embodiment of the present invention is shown and described, it is envisioned that those skilled in the art may devise various modifications of the present invention.

The invention that is claimed is:

1. A scuff and wall plate, comprising:
a scuff plate formed of thermoplastic fiberglass-reinforced plastic;
a wall liner formed of thermoplastic fiberglass-reinforced plastic, said scuff plate and said wall liner being fused together.

2. The scuff plate of claim 1, wherein said scuff plate is fused to said wall liner by glass fiber blooming.

3. The scuff plate of claim 2, wherein said glass fiber blooming comprises at least one of vibration welding and high frequency welding.

4. The scuff plate of claim 1, wherein said scuff plate has a predetermined height, and said scuff plate is fused to said wall liner at a lap area which is smaller than the height of said scuff plate.

5. A trailer comprising:
a floor,
a sidewall extending from said floor,
a thermoplastic fiberglass-reinforced plastic wall liner formed as an interior side of said sidewall,
a thermoplastic fiberglass-reinforced plastic scuff plate fused to said wall liner.

6. The trailer of claim 5, wherein said scuff plate is fused to said wall liner by glass fiber blooming.

7. The trailer of claim 6, wherein said glass fiber blooming comprises at least one of vibration welding and high frequency welding.

8. The trailer of claim 5, wherein said scuff plate has a predetermined height, and said scuff plate is fused to said wall liner at a lap area which is smaller than the height of said scuff plate.

9. The trailer of claim 8, wherein said scuff plate has a predetermined height, and said wall liner is mounted a distance above said floor, said distance being less than said scuff plate height.

10. The trailer of claim 9, wherein said lap area has a height, and the sum of said height of said lap area plus said distance of said wall liner above said floor is approximately equal to said scuff plate height.

11. A method of forming a scuff and wall plate, comprising:
providing a scuff plate formed of thermoplastic fiberglass-reinforced plastic;
providing a wall liner formed of thermoplastic fiberglass-reinforced plastic; and
fusing said scuff plate and said wall liner together.

12. The method of claim 11, wherein said scuff plate is fused to said wall liner by glass fiber blooming.

13. The method plate of claim 12, wherein said glass fiber blooming comprises at least one of vibration welding and high frequency welding.

14. The method of claim 1, wherein said scuff plate has a predetermined height, and said scuff plate is fused to said wall liner at a lap area which is smaller than the height of said scuff plate.
